(19) United States
(12) Patent Application Publication
(10) Pub. No.: US 2005/0224660 A1
(43) Pub. Date: Oct. 13, 2005

(54) Hexagonal kite

(76) Inventors: Patrick M. May, Casper, WY (US); Deborah J. May, Casper, WY (US)

Correspondence Address: LITMAN LAW OFFICES, LTD, PO BOX 15035, CRYSTAL CITY STATION, ARLINGTON, VA, 22215, US

(21) Appl. No.: 11/087,655

(22) Filed: Mar. 24, 2005

Related U.S. Application Data
(60) Provisional application No. 60/555,714, filed on Mar. 24, 2004.

(51) Int. Cl. B64C 31/06

(52) U.S. Cl. 244/153 R

(57) ABSTRACT

The hexagonal kite has a generally central spar attach fitting having a series of receptacles therein, into which the six spars of the kite are installed. A peripheral tension member extends around the distal ends of the spars to define the hexagonal shape of the kite. The two upper or forwardmost spars are shortest, with the two lower or rearmost spars being longest and the two lateral spars being of intermediate length. This results in the kite surface behind the lateral spars having a larger area than the surface in front of the lateral spars, which results in greater stability and need for a smaller stabilizing tail. The bridle is generally centered on the somewhat forwardly placed spar attachment disc, resulting in the aerodynamic center being located behind the bridle for further stability.

### CROSS-REFERENCE TO RELATED APPLICATION

This application claims the benefit of U.S. Provisional Patent Application Ser. No. 60/555,714, filed Mar. 24, 2004.

### BACKGROUND OF THE INVENTION

1. Field of the Invention

The present invention relates generally to tethered aerodynamic devices, and more particularly to various embodiments of a hexagonal kite. The structure of the present kite is provided by a somewhat forwardly disposed disc which secures the inboard ends of a series of six generally radially disposed spars, with the distal ends of the spars defining the corners of the hexagonal form. The angular spacing and lengths of the spars are adjusted to provide a shorter upper or leading edge for the kite, thereby placing the central spar connector with its central bridle line closer to the aerodynamic center and moving the aerodynamic center rearwardly or downwardly relative to the tether for greater stability.

2. Description of the Related Art

Kites tethered to some point on the ground, e.g., by a kite flyer holding the fixed end of the tether line, have been known for thousands of years. While innumerable different kite shapes have been developed over the centuries, perhaps the best known is the conventional rhomboid or diamond shaped kite, with its cruciform spar arrangement. Such kites have the advantage of being lightweight and simple to construct, but suffer various aerodynamic disadvantages.

A problem with such rhomboid kites is that the widest portion of the kite is relatively far forward, thus resulting in the aerodynamic center of pressure being relatively far forward as well. The bridle conventionally extends from the tips of the four spars of such a kite, and while the center of the bridle is somewhat closer to the upper or forward end of the kite, this configuration still results in the aerodynamic center of pressure being higher or farther forward than the center of tensile force provided by the bridle. This is the reason such kites, and most other kite configurations, require a tail, i.e., to provide additional mass and aerodynamic area below and to the rear of the center of the bridle for stability.

The present hexagonal kite provides at least a partial solution to the chronic problem of aerodynamic instability by means of a different kite planform. The present hexagonal kite provides a central, generally disc-shaped fitting to which the six spars are secured and from which the spars extend in a generally radial configuration. However, the six spars are of three different lengths, with the forwardmost or uppermost spars being shortest, the two lateral spars having intermediate lengths, and the two lowermost or rearmost spars having the greatest lengths. This places the spar attachment disc somewhat closer to the upper or leading edge of the kite, and results in a shorter lateral span between the distal ends of the two shorter leading spars. The result is relatively less forward area, which shifts the aerodynamic center somewhat rearwardly relative to the bridle and results in a need for a smaller tail for the kite.

A discussion of the related art of which the present inventors are aware, and its differences and distinctions from the present invention, is provided below.

U.S. Pat. No. 3,767,145 issued on Oct. 23, 1973 to Raymond P. Holland, Jr., titled “Kites,” describes a flexible kite structure having a pair of generally parallel longerons with a flexible span therebetween and flexible extensions to each side. Holland, Jr. teaches away from the present hexagonal kite due to the laterally flexible structure of his kite, the lack of any rigid central structure, provision for only two lateral attachments for the bridle, and lack of any form of structure (e.g., string or cord, etc.) to define the periphery of his kite.

U.S. Pat. No. 6,062,510 issued on May 16, 2000 to Carlos De La Melena, titled “Kite,” describes a kite having an octagonal periphery and a complex, three-dimensional rigid frame to hold the tension lines providing the shape for the kite. The De La Melena kite frame does not provide a single, central fitting from which a series of radially disposed spars extend, as provided in the present hexagonal kite configuration. The surface of the De La Melena kite is porous, and provides for the removable placement of various non-porous shapes thereon to act as aerodynamic surfaces. De La Melena provides a multiple line tether to control his kite, and may optionally provide additional such tethers for the non-porous patterns placed on the porous surface of his kite. No multiple line bridle connecting to a single tether line is provided by De La Melena.

U.S. Pat. No. 6,499,695 issued on Dec. 31, 2002 to Robert O. Talamo, titled “Balloon Kite,” describes a pair of embodiments of a pneumatically inflatable kite. One of the embodiments has a parasail configuration comprising a series of longitudinal tubes and a lateral leading edge tube. However, the closest embodiment to the present hexagonal kite invention is a kite having a conventional rhomboid configuration. The Talamo rhomboid kite includes only a two-line bridle with the lines attached at the laterally opposed corners, rather than having a multiple bridle line configuration as in the present hexagonal kite. Most critical is the fact that Talamo does not provide any form of rigid structure in his kites, due to their inflation.

U.S. Patent Publication No. 2002/20,784, published on Feb. 21, 2002, titled “Flexible Kite,” describes a flexible parasail type kite, with no rigid structure. The only structural members which are not completely flexible are semi-rigid, somewhat flexible fiberglass rods used as the leading and lateral edge members, to which the bridle lines are attached. This configuration teaches away from the present hexagonal kite, with its flexible peripheral members and rigid, or at least semi-rigid, radially disposed spar structure extending from a generally central fitting.

U.S. Design Pat. No. 246,807 issued on Dec. 27, 1977 to Aaron C. Moore, titled “Kite,” illustrates a design having a polygonal shape with diagonal cross bracing. However, no central fitting is apparent in the Moore design, and no bridle configuration is disclosed.

U.S. Des. Pat. Nos. 428,069 and 428,070, both issued on Jul. 11, 2000 to Chen Nan Cheng and titled “Kite,” illustrate designs having configurations resembling that of a hot air balloon. The balloon portions of the Cheng kite designs are generally flat and planar with a conventional rigid crossmember(s), but the outer edges are shaped to provide overall outlines similar to that of a hot air balloon. The tails of the Cheng kites are open cylindrical structures, made to resemble the gondola of the balloon. The primary differences between the '069 and '070 designs of Cheng are that (1) the '070 design does not include a lateral brace spar, and (2) the '070 design includes a larger, spiral tail extending below the gondola tail structure. The Cheng kite design configuration teaches away from the present kite, in that among other points of difference, Cheng provides the greatest aerodynamic area at the forward or upper portion of his kite, hence the need for the relatively large tail portion.

Japanese Patent Publication No. 10-165,660 published on Jun. 23, 1998, titled “Foldable Kite,” describes (according to the drawings and English abstract) a kite folded of a single sheet of material, with the center of the sheet folded to form a vertical surface and the outer portions extending outwardly therefrom to form flying surfaces. A single lateral spar passes across the vertical surface and attaches to the two flying surfaces to provide rigidity for the assembly. No generally central spar fitting with a series of spars radiating outwardly therefrom, is disclosed in the '660 Japanese Patent Publication.

Finally, Japanese Patent Publication No. 10-305,177 published on Nov. 17, 1988, titled “Kite And Manufacture Therefor,” describes (according to the drawings and English abstract) a method of cutting, folding, and gluing a plain sheet of material, such as a sheet formed from opening a shopping bag and folding it flat, into a kite. The completed kite configuration appears to closely resemble kite of the '145 U.S. patent to Holland, Jr., discussed further above. The same points of difference noted between the Holland, Jr. kite and the present hexagonal kite, are seen to apply here as well.

None of the above inventions and patents, taken either singly or in combination, is seen to describe the instant invention as claimed. Thus, a hexagonal kite solving the aforementioned problems is desired.

### SUMMARY OF THE INVENTION

The hexagonal kite incorporates various structural and aerodynamic improvements over earlier kites of the related art. The hexagonal configuration is provided by a central disc having a series of six sockets disposed therearound, with six rigid, or semi-rigid, spars extending outwardly therefrom. A tension member (string, etc.) extends around the distal ends of the spars to define the periphery of the kite, and to serve as an attachment edge for the aerodynamic surface or cover for the present kite. A bridle attaches to the distal ends of the six spars and to the central disc, with a tether line (kite string, etc.) attaching to the bridle.

The hexagonal kite has a novel planform, in that the hexagonal shape is not regular. The upper or forwardmost two spars are relatively short, with the lower or rearmost two spars being the longest of the spars. The two lateral spars have lengths intermediate between the forward and rearward spars. This results in the portion of the kite forward of the lateral spars having a smaller area than the portion rearward of the lateral spars, with the uppermost or leading edge of the kite surface being shorter than the lowermost or trailing edge of the surface. This results in the aerodynamic area forward of the lateral spars being considerably less than the area rearward of the lateral spars. As the bridle is generally centered from the spar attachment disc, it will be seen that the bridle is ahead of the aerodynamic center of the present kite. This provides much greater stability for the present kite in comparison to other conventional kite configurations, and greatly reduces the need for a stabilizing tail.

These and other features of the present invention will become apparent upon consideration and review of the following specification and drawings.

### BRIEF DESCRIPTION OF THE DRAWINGS

FIG. 1 is a perspective view of a hexagon shaped kite according to the present invention, as it would be deployed in flight.

FIG. 2 is a rear elevation view of the present hexagonal kite, showing the configuration of its spars and lateral bow string.

FIG. 3A is a detail perspective view of a first embodiment of the spar attachment disc, showing the fitting of spars having round or cylindrical cross sections thereto.

FIG. 3B is a detail perspective view of another embodiment of the spar attachment disc, configured for the installation of spars having square or rectangular cross sections therewith.

FIG. 4A is a detail perspective view of one of the spar tip fittings configured for use with a spar having a round or cylindrical cross section.

FIG. 4B is a detail perspective view of an alternative embodiment spar tip fitting, configured for use with a spar having a square or rectangular cross section.

Similar reference characters denote corresponding features consistently throughout the attached drawings.

### DETAILED DESCRIPTION OF THE PREFERRED EMBODIMENTS

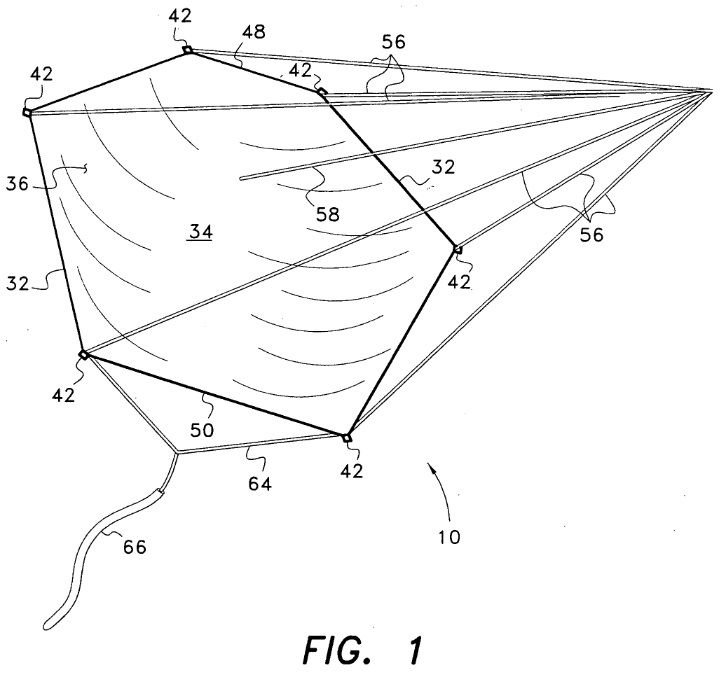

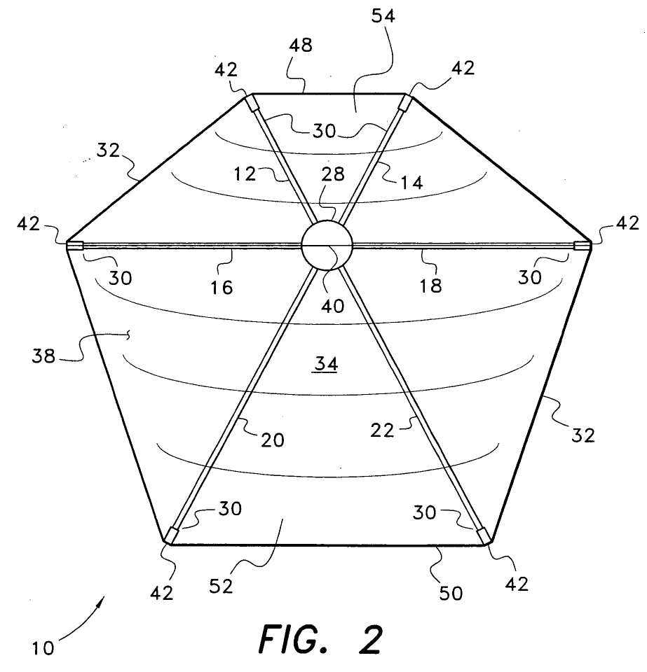

The present invention comprises various embodiments of a hexagonal kite that provides various improvements in structural and aerodynamic efficiency in comparison to conventional kites. FIGS. 1 and 2 respectively provide front perspective and rear elevation views of the present kite, designated by the reference character 10. The present kite 10 has a hexagonal planform, defined by the ends of the six radially disposed spars as shown in FIG. 2. The relative lengths of these spars and their interconnection provide certain structural and particularly aerodynamic advantages, as discussed in detail further below.

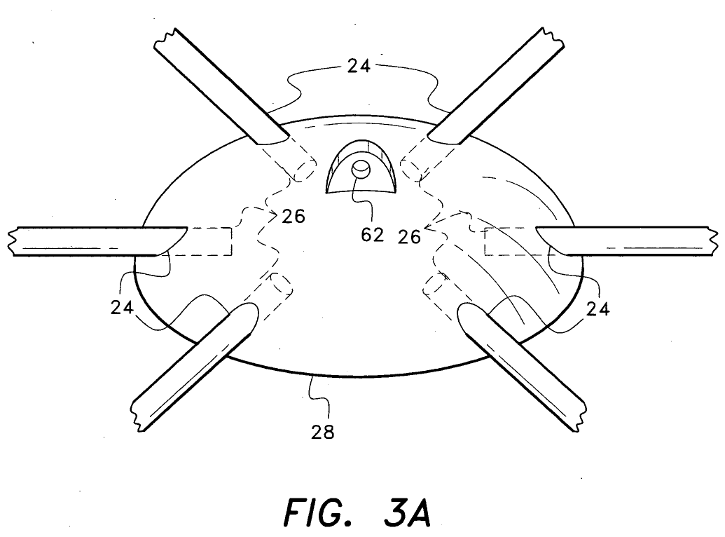

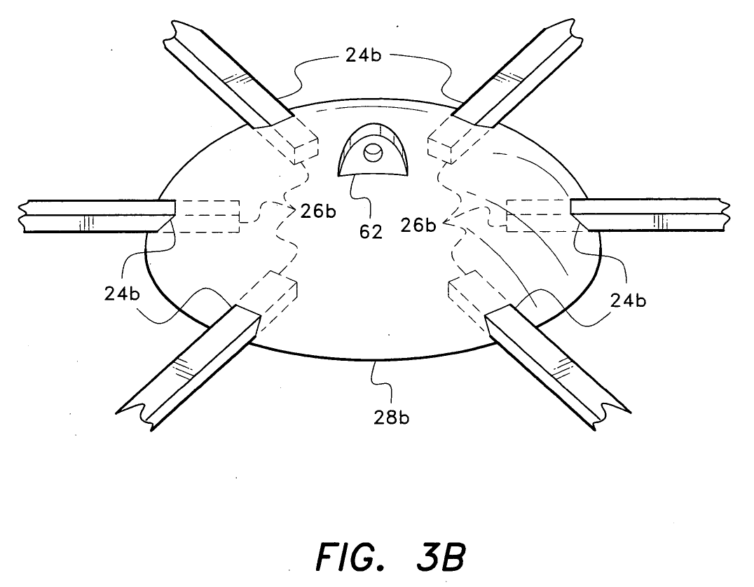

FIG. 2 provides a view of the spar structure of the present hexagonal kite 10. The kite 10 shape is defined by a series of six elongate spars, comprising two forwardly disposed spars 12 and 14, two mutually opposed lateral spars 16 and 18, and two rearwardly disposed or aft spars 20 and 22. The spars 12 through 22 may be formed of wood, solid or hollow Nylon® or other plastic rod, or other material as desired. Each spar 12 through 22 has a fitting installation end 24, which installs either removably or permanently in one of the six radially disposed, coplanar sockets or receptacles 26 of the generally centrally disposed spar attachment fitting or disc 28. Details of this fitting 28 are shown in FIG. 3A, for spars having round or cylindrical cross sections, with corresponding fitting 28b being shown in FIG. 3B having square or rectangular sockets 26b for spars with fitting installation ends 24b with corresponding cross sections.

Each of the spars 12 through 22 has a distal end 30, with a peripheral tensile member 32 (e.g., cord, string, etc.) extending about the distal tips 30 of the spars 12 through 22 to define the hexagonal periphery of the present kite 10. The kite 10 is covered by a flight surface 34 of paper, Nylon® or other plastic sheet, or other material as desired. The flight surface 34 includes a windward side 36 (FIG. 1) and an opposite back side 38 (FIG. 2) and extends across all of the radially disposed spars 12 through 22, attaching to the peripheral tensile member 32. A tensile bow string 40 extends across the span of the two lateral spars 16 and 18, and across the back side 38 of the flight surface 34, bowing the two lateral spars 16 and 18 rearwardly.

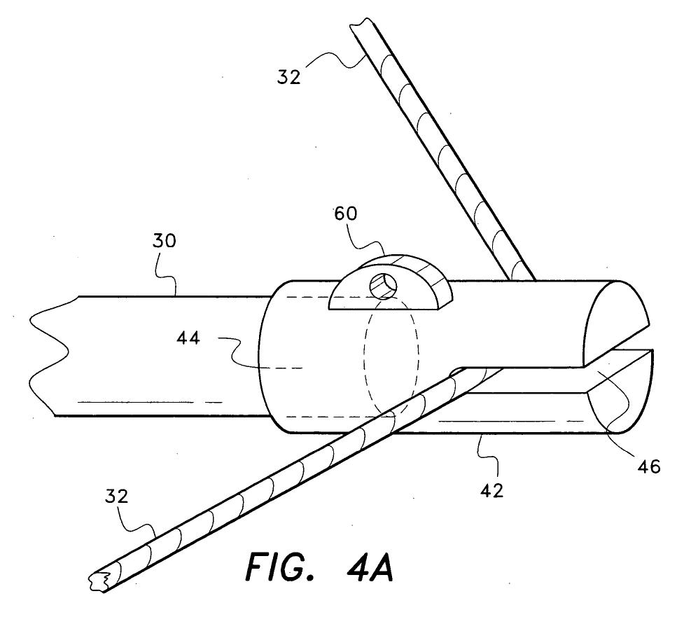

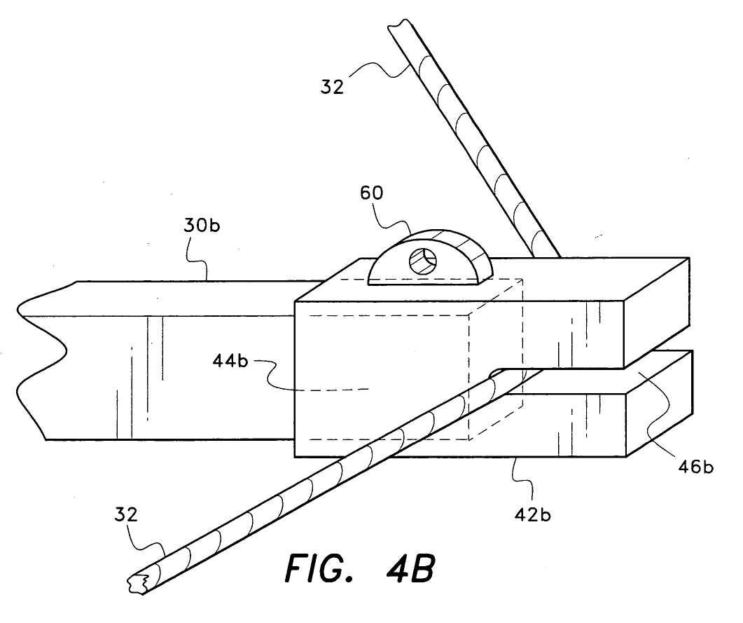

FIGS. 4A and 4B illustrate different embodiments of the spar end caps which are provided with the present hexagonal kite 10. In FIG. 4A, a spar end cap 42 is shown, with the end cap 42 having a spar attachment socket 44 into which the distal end 30 of one of the spars 12 through 22 is installed. The distal end of the cap 42 opposite the spar attachment socket 44 includes a slot 46 for the installation of the peripheral tensile member 32 therein. FIG. 4B illustrates a spar end cap 42b which is functionally like the end cap 42 of FIG. 4A, but which includes a square or rectangular socket 44b for a spar having a square or rectangular cross section and distal end 30b. It will be understood that the cross sectional shapes of the various spars, spar attachment fitting sockets, and end cap sockets are not critical, so long as they are compatible with one another in any given kite construction.

Returning to FIG. 2, it will be noted that the various spars 12 through 22 are not equal in length to one another. This is a critical feature of the present hexagonal kite 10, and provides much of the aerodynamic advantage of the kite 10. It will be noted in FIG. 2 that the two forward or front spars 12 and 14 are relatively short in comparison to the other spars, with the two opposed lateral spars 16 and 18 being somewhat longer than the two front spars 12 and 14. The two rearward or aft spars 20 and 22 are the longest of any of the spars 12 through 22. The specific ratios of the lengths of the front, lateral, and aft spars, as well as the overall size of the kite 10, may be adjusted as desired to provide the desired aerodynamic effects.

While it is not a requirement that the opposite spars, e.g., 12 and 22, or 14 and 20, be in alignment with one another, preferably the alignment of the spar attachment receptacles 26 in the spar attachment fitting 28 provides for such alignment. When the opposite spar members are aligned with one another, the included angle between the two front spars 12 and 14 will be identical to the included angle between the two rear spars 20 and 22. As the two front spars 12 and 14 are shorter than the two rear spars 20 and 22, the span across the distal ends 30 of the two front spars 12 and 14, which defines the leading edge 48 of the kite 10, will be shorter than the span across the distal ends 30 of the two aft spars 20 and 22 defining the trailing edge 50 of the kite 10.

The above-described geometry also results in the placement of the two opposed lateral spar members 16 and 18 and the spar attachment fitting 28, closer to the leading edge 48 than to the trailing edge 50. The greater distance between the maximum span of the kite 10, as defined by the span of the two lateral spar members 16 and 18, and the trailing edge 50, in comparison to the distance between the lateral spar members 16 and 18 and the leading edge 48, along with the wider span of the trailing edge 50 in comparison to the leading edge 48, results in considerably greater flight surface area for the rearward portion 52 of the kite 10 between the lateral spars 16 and 18 and the trailing edge 50, than for the forward portion 54 of the kite 10 between the lateral spars 16 and 18 and the leading edge 48.

This relatively larger rearward surface area 52 results in the aerodynamic center of pressure being located somewhat rearwardly of its location in a conventional kite, with the aerodynamic center of the present kite 10 perhaps being located behind or to the rear of the spar attachment fitting 28. This greatly assists the stability of the present kite 10, as the central line for the bridle extends from the spar attachment fitting 28.

FIG. 1 of the drawings illustrates the bridle configuration for the present hexagonal kite 10. The bridle assembly comprises a series of six peripheral bridle lines 56 which extend from the distal ends 30 of the six spars 12 through 22, and a central bridle line 58 which extends from the spar attachment fitting 28. The bridle assembly extends from the windward surface 34 of the kite 10, with the central bridle line penetrating through the flight surface 34. Each of the peripheral bridle lines 56 attaches to the kite 10 at an eye 60 extending from the spar end cap 42 (FIG. 4A) or 42b (FIG. 4B), with the central bridle line 58 attaching to a similar eye 62 extending from the spar attachment fitting 28 (FIG. 3A) or 28b (FIG. 3B). The various bridle lines 56 and 58 join one another in front of the kite 10 at their mutual kite line connector ends 64, where they connect to a conventional kite line or string (not shown). The placement of the tensile center of the bridle assembly at the relatively forwardly positioned spar attachment fitting 28, along with the larger rearward surface area 52, greatly enhance the aerodynamic stability of the present hexagonal kite 10.

In the event that even greater aerodynamic stability is required, a tail assembly may be added to the kite 10, as shown in FIG. 1. The tail assembly comprises a tail attachment bridle 64 which extends across the span of the trailing edge 50, between the distal ends 30 of the two aft spars 20 and 22. The ends of the bridle 64 may be secured to the kite 10 by means of the eyes 60 of the spar end caps 42 affixed to the distal ends 30 of the two rearward spars 20 and 22. A tail 66 is then attached to the tail attachment bridle 64, preferably generally medially therealong. The tail 66 may be formed of conventional materials known to be of use for such purposes, e.g., a strip or strips of fabric or other material secured to the bridle 64 with string or cord, etc. The size and length of the tail 66 may be adjusted as required, depending upon the aerodynamic stability of the kite 10 with its different forward and rearward areas 54 and 52, the materials used in the construction of the present kite 10 and its tail 66, and the amount of wind and turbulence anticipated for any given kite flying session.

In conclusion, the hexagonal kite provides various improvements in aerodynamics and structure for kites. The irregular hexagon shape, with its leading edge smaller than the trailing edge, results in greater aerodynamic area rearward of the central bridle attachment, thereby shifting the center of pressure rearwardly relative to the bridle attachment to provide greater stability. Thus, the present kite requires a smaller tail to provide the required stability, particularly in consideration of the seven-point bridle attachment system.

The kite may be constructed of any suitable materials and to any practicable size, as desired. The three diagonally opposed spar pairs, i.e., the two lateral spars, the left forward and right rear spars, and the right forward and left rear spars, have the same total length. Thus, a diagonal measurement across any two opposed spar tips, will be equal to the diagonal measurement across any other two opposed spar tips. This results in a decrease in the area of the forward portion of the kite as the rearward area is increased, as the forward spars are shortened and the rearward spars are lengthened to place the central attachment fitting or disc closer to the leading edge of the kite. Accordingly, the aerodynamic stability is improved, as explained further above. The hexagonal kite, with its improved aerodynamic stability, ease of construction, and durability provided by the central spar attachment fitting and distal spar tip fittings, will prove to be widely accepted by those who enjoy the hobby of kite flying.

It is to be understood that the present invention is not limited to the embodiments described above, but encompasses any and all embodiments within the scope of the following claims.

1. A hexagonal kite, comprising:
a spar attachment fitting having six radially disposed, coplanar spar receptacles;
a pair of front spars, a pair of opposed lateral spars, and a pair of aft spars, each of the spars having an elongate configuration and having a fitting installation end and a distal end opposite the fitting installation end, the spars being installed in and extending radially from the spar receptacles of said spar attachment fitting;
a peripheral tensile member extending about and connecting each of the distal ends of the spars, and defining a hexagonal kite periphery;
a flight surface having a windward side and a back side opposite the windward side, the flight surface spanning said kite periphery; and
a bridle extending from the windward side of said flight surface.

2. The hexagonal kite according to claim 1, further including a spar end cap having a spar attachment socket and a distal tensile member slot opposite said spar attachment socket, the spar end cap being installed upon the distal end of each of said spars, the peripheral tensile member being secured within the tensile member slot of each said spar end cap.

3. The hexagonal kite according to claim 1, wherein:
said front spars are shorter than said lateral spars, and said aft spars are longer than said lateral spars;
said kite periphery has a leading edge and a trailing edge, the trailing edge having a longer span than the leading edge;
said mutually opposed lateral spars define a forward portion and a rearward portion for said flight surface; and
the rearward portion of said flight surface has a greater aerodynamic surface area than the forward portion of said flight surface.

4. The hexagonal kite according to claim 1, further including a bow string drawn tautly from each of the distal ends of said opposed lateral spars, the bow string spanning the back side of said flight surface and bowing each of the distal ends of said lateral spars rearwardly.

5. The hexagonal kite according to claim 1, wherein said bridle further comprises:
a peripheral bridle line extending from said distal end of each said spar; and
a generally central bridle line extending from said spar attachment fitting, each of the bridle lines having a kite line connector end and being joined to one another thereat forwardly of the windward side of said flight surface.

6. The hexagonal kite according to claim 1, further including a tail assembly extending rearwardly therefrom.

7. The hexagonal kite according to claim 6, wherein said tail assembly further comprises:
a tail attachment bridle extending between the distal end of each of said aft spars; and
a tail extending rearwardly from said tail attachment bridle.

8. A hexagonal kite, comprising:
a spar attachment fitting having six radially disposed coplanar spar receptacles;
a plurality of elongate spars, each of the spars having a fitting installation end and a distal end opposite the fitting installation end, the spars being installed in, and extending radially from, the spar receptacles of said spar attachment fitting;
a plurality of spar end caps, each of the end caps having a spar attachment socket and a distal tensile member slot opposite the spar attachment socket, the end caps being installed upon the distal ends of the spars, each of the spars having one of the end caps installed thereon;
a peripheral tensile member secured within the tensile member slot of each of the spar end caps, the tensile member extending about and connecting the distal ends of the spars and defining a hexagonal kite periphery; and
a flight surface having a windward side and a back side opposite the windward side, the flight surface spanning said kite periphery.

9. The hexagonal kite according to claim 8, wherein:
said plurality of spars comprises a pair of front spars, a pair of opposed lateral spars, and a pair of aft spars, the front spars being shorter than the lateral spars, and the aft spars being longer than the lateral spars;
said kite periphery has a forward edge and a rearward edge, the rearward edge having a longer span than the forward edge;
said mutually opposed lateral spars define a forward portion and a rearward portion for said flight surface; and
the rearward portion of said flight surface has a greater aerodynamic surface area than the forward portion of said flight surface.

10. The hexagonal kite according to claim 9, further including a bow string drawn tautly from each of the distal ends of said opposed lateral spars, the bow string spanning the back side of said flight surface and bowing each of the distal ends of said lateral spars rearwardly.

11. The hexagonal kite according to claim 8, further including a bridle extending from the windward side of said flight surface.

12. The hexagonal kite according to claim 11, wherein said bridle further comprises:
a peripheral bridle line extending from said distal end of each of said spars; and
a generally central bridle line extending from said spar attachment fitting, each of the bridle lines having a kite line connector end and being joined to one another thereat, forwardly of the windward side of said flight surface.

13. The hexagonal kite according to claim 8, further including a tail assembly extending rearwardly therefrom.

14. The hexagonal kite according to claim 13, wherein said tail assembly further comprises:
a tail attachment bridle extending between the distal end of each of said aft spars; and
a tail extending rearwardly from said tail attachment bridle.

15. A hexagonal kite, comprising:
a spar attachment fitting having six radially disposed, coplanar spar receptacles;
a pair of radially spaced apart, short front spars extending from said spar attachment fitting;
a pair of mutually opposed, intermediate length lateral spars extending from said spar attachment fitting;
a pair of radially spaced apart, long aft spars extending from said spar attachment fitting, the front spars, lateral spars and aft spars each having a distal end;
a peripheral tensile member extending about and connecting the distal ends of the spars, and defining a hexagonal kite periphery, the kite periphery having a leading edge and a trailing edge, the trailing edge having a longer span than the leading edge;
a flight surface having a windward side and a back side opposite the windward side, the flight surface spanning the kite periphery, the lateral spars defining a forward portion and a rearward portion of the flight surface, the rearward portion having a greater aerodynamic surface area than the forward portion of the flight surface; and
a bridle extending from the windward side of the flight surface.

16. The hexagonal kite according to claim 15, further including a spar end cap having a spar attachment socket and a distal tensile member slot opposite the spar attachment socket, the spar end cap being installed upon the distal end of each of said spars, said peripheral tensile member being secured within the tensile member slot of each said spar end cap.

17. The hexagonal kite according to claim 15, further including a bow string drawn tautly from each of the distal ends of said opposed lateral spars, the bow string spanning the back side of said flight surface and bowing each of the distal ends of said lateral spars rearwardly.

18. The hexagonal kite according to claim 15, wherein said bridle further comprises:
a peripheral bridle line extending from the distal end of each said spar;
a generally central bridle line extending from said spar attachment fitting; and
each said bridle line having a kite line connector end and being joined to one another thereat, forwardly of the windward side of said flight surface.

19. The hexagonal kite according to claim 15, further including a tail assembly extending rearwardly therefrom.

20. The hexagonal kite according to claim 19, wherein said tail assembly further comprises:
a tail attachment bridle extending between the distal end of each of said aft spars; and
a tail extending rearwardly from said tail attachment bridle.
